(19) United States
(12) Patent Application Publication
(10) Pub. No.: US 2015/0160055 A1
(43) Pub. Date: Jun. 11, 2015

(54) Apparatus for Measurement of a Multi-Phase Fluid Mixture

(71) Applicants: Stepan Polikhov, Ramenskoye (RU); Anton Valeev, Moscow (RU)

(72) Inventors: Stepan Polikhov, Ramenskoye (RU); Anton Valeev, Moscow (RU)

(21) Appl. No.: 14/397,182

(22) PCT Filed: Apr. 25, 2012
(86) PCT No.: PCT/RU12/00319

§ 371 Date: Feb. 23, 2015

(51) Int. Cl. G01F 1/74; G01N 23/04; G01T 1/24

(52) U.S. Cl. CPC G01F 1/74; G01T 1/247; G01N 23/04

(57) ABSTRACT

An apparatus for measurement of a flow velocity of a multi-phase fluid mixture includes a radiation device configured to generate a sequence of pulses of photons for irradiating a section of the flow of the mixture. The photons are emitted at at least a first energy level and a second energy level. The apparatus includes a detection device configured to detect photons that transmitted the section of the flow at different time intervals so as to generate a first image of the spatial distribution of detected photons of the first energy level and a second image of the spatial distribution of detected photons of the second energy level. The apparatus includes an analysis device configured to determine the flow velocity of one or more phases of the mixture based on a temporal sequence of the first image and the second image of the spatial distributions.

This application is the National Stage of International Application No. PCT/RU2012/000319, filed Apr. 25, 2012. The entire contents of this document are hereby incorporated herein by reference.

### BACKGROUND

The present embodiments relate to measurement of a flow velocity of a multi-phase fluid mixture.

In the chemical industry (e.g., in the oil and gas industry), it is desired to precisely measure the flow velocity and a composition of a multi-phase fluid mixture conducted in a conduit. Ideally, the flow is not interrupted by the measurement procedure.

Nowadays, this problem is addressed by flow meters that evaluate the relative composition of the constituents of the mixture and the flow rate by observing photons (e.g., x-rays or gamma-rays) that transmitted the flow of the multi-phase fluid mixture. The photons are emitted by a radiation device at at least two different energy levels. The energy levels of the photons are chosen with respect to the absorption coefficients of the different phases of the multi-phase mixture.

A prominent example encountered frequently in the field of oil or gas industry is the evaluation of parameters for a mixture effluent from a well that includes oil, water and gas as constituting phases. A section of a pipe containing the mixture is irradiated with photons of a first energy level, where, for the first energy level, the absorption coefficients for oil and water are substantially the same. Photons emitted at a second energy level are absorbed significantly stronger by water than by oil. The photons are detected by a detection device that is at least sensitive to photons of the first and second energy level. Analysis of the signals (e.g., analysis of first and second images recorded from spatial distributions of the detected electrons of the first and second energy level) allows for an evaluation of the oil, water and gas concentrations and respective flow rates.

Other flowmeter devices according to prior art include restrictions of the diameter of the conduit conducting the fluid flow such as Venturi restrictions to measure the flow rate. Such restrictions have a negative impact on the flow rate.

WO 2011/005133 A1 describes an apparatus for measuring the flow rate of the multi-phase fluid that does not rely on the necessity of introducing a restriction to the fluid flow. A section of the conduit conducting the multi-phase fluid is irritated by photons of the first energy level and by photons of the second energy level. The photons of the first energy level emanate from a first x-ray tube, and the photons of the second energy level emanate from a second x-ray tube. The x-ray tubes may be operated in a continuous or a pulsed mode. In the pulsed mode, pulses are alternately generated such that photons of the first energy are included in a first pulse and the photons of the second energy are included in a second pulse following the first pulse.

The flow rate is evaluated from the sequence of first images showing spatial distributions generated from the detected electrons of the first energy level at different time intervals and from the temporal sequence of second images generated from spatial distributions recorded from detected electrons of the second energy level at different time intervals. For example, the flow rate is evaluated from cross-correlations observed in the temporal sequence of first and second images.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, an apparatus for measurement of a flow velocity of the multi-phase fluid mixture with improved accuracy.

A radiation device of the apparatus is configured to generate single pulses including photons of different energy levels. Each pulse includes at least photons emitted at the first energy level and at the second energy levels.

Accordingly, at least one first image showing a spatial distribution of electrons of the first energy level and at least one second image showing a distribution of electrons of the second energy level are recorded by the detection device during the time interval corresponding to the duration of each pulse. The detection device is thus capable of operating at high repetition rates. Hence, the accumulation of data containing information about the flow velocity of the multi-phase mixture is increased and, consequently, statistical errors when evaluating the measured data including the recorded sequences of first and second images are reduced. The apparatus thus features an increased accuracy.

In one embodiment, the radiation device includes a single x-ray tube and a control device configured to time-dependently adjust the energy level of the photons emitted by the x-ray tube. This is done in a manner, so that each pulse emitted by the x-ray tube includes at least photons emitted at the first energy level and the second energy level. The radiation device including only one x-ray tube has a very compact design and is particularly suited for being used at locations where space is limited such as oil platforms. Production costs are reduced, as only a single x-ray tube is used for generating the photons at different energy levels. Generation of photons at different energy levels is achieved by a suitable time-dependent activation carried out by the control device.

In further development, the control unit is configured to continuously vary a voltage applied to the x-ray tube so as to adjust the energy level of the photons emitted by the x-ray tube. The x-ray tube emits a continuous Bremsstrahlungs-spectrum, where the minimal energy of the photons emitted by the x-ray tube depends on the voltage applied across an anode and a cathode of the x-ray tube. Continuous variation of the voltage shifts the Bremsstrahlungs-spectrum, so that, by choosing a suitable range for the variation of the voltage, photons of the first energy level and photons of the second energy level are emitted by the x-ray tube.

In one embodiment, the control device and the detection device are connected in a control circuit configured to time-dependently adjust the number of emitted photons contained in each pulse. The number of photons is adjusted according to a sensitivity of the detection device. For example, the number of photons is adjusted to the sensitivity for photons of the first and/or second energy level. The feedback from the detection device to the control device controlling the radiation device allows for maintaining the number of emitted photons in a region optimal for detection. Thus, the accuracy of detection is further increased. As each pulse contains energy bands with photons of different energy levels (e.g., at least one energy band including the photons of the first level and at least another energy band including the photons of the second energy level) that are separated in time, the number of photons emitted in each band may be adjusted by a suitable time-dependent actuation of the x-ray tube.

In one embodiment, the control unit is adapted to continuously vary a current applied to the x-ray tube so as to time-dependently adjust a number of photons contained in each pulse. For example, the current for heating the cathode of the x-ray tube may be adjusted so that, depending on the sensitivity of the detection device, a sufficient number of electrons emitted from the cathode reach the anode to generate photons of the first and/or second energy level.

The detection device may include a two-dimensional array of detection elements. Accordingly, the analysis device may be configured to determine an average fluid velocity for a part of the flow of the mixture located in a layer of the irradiated section of the fluid flow. The average fluid velocity of the layer of the fluid flow is evaluated from data detected by a subsection of the array of detection elements oriented parallel to the conduit. In one embodiment, a plurality of average velocities of layers are estimated, where each average velocity relates to one layer of the irradiated fluid flow that extends parallel to the conduit. The profile of fluid flow typically encountered when a fluid is conducted in a conduit may be more accurately accounted for. It is known that layers close to a boundary surface exhibit lower average flow velocities as the effects of viscosity are significant in this region; layers located close to the center of the conduit flow at higher velocities. Separate evaluation of the average flow velocities for the different layers of the fluid flow accounts for a more accurate and realistic hydrodynamic situation. Accordingly, the detection elements of the detector device are two-dimensionally arranged as a matrix that is subdivided into a number of subsections. Each subsection extends parallel to the fluid flow. The local velocity profile of the flow dependent on the width of the conduit may be evaluated. Timing between the acquisitions of the first image and/or the second image may be adjusted dependent on the local velocity field of the flow to provide more accurate measurement results. Information retrieved from discrete data (e.g., data that was not a subject to a process of averaging) may be used as additional information (e.g., for determining the concentration of the different phases contained in the mixture).

According to various embodiments, the conduit has a circular, rectangular or square cross section. In one embodiment, the conduit conducting the flow of the mixture has an elliptic cross-section in at least the irradiated section. As discussed herein, certain layers (e.g., boundary layers) adjacent to a wall or boundary of the conduit encounter effects of viscosity. Thus, the flow velocities in the boundary layers are reduced. The photons emitted by the radiation device substantially pass the conduit along the major axis of the elliptic cross section. In comparison to a conduit having a square cross-section, the thickness of the boundary layers along the major axis of a conduit of elliptic shape is reduced. If the conduit is monitored such that the photons pass the wider extent (e.g., along the major axis) of the conduit, the influence of boundary layers on the evaluation of the average velocity is reduced.

In one embodiment, the analysis device is configured to determine the flow velocity of one or more phases or constituents of the mixture based on the cross-correlations contained in the temporal sequence of first images and/or second images. Determination of the flow velocity utilizing a device of image analysis obsoletes the introduction of a restriction in the conduit such as a Venturi restriction. Accordingly, the apparatus is configured to continuously monitor the flow in the conduit during operation of the industrial plant (e.g., during operation of the oil rig including the conduit). The flow of the mixture is not influenced by the apparatus or the measurement procedure. Even more particularly, the flow may be continuously monitored, and corresponding actions may be taken to keep the concentration of the various phases contained in the mixture or the flow velocity in a desired range.

According to various embodiments, the flow velocity of the mixture may be about 10 meters per second. Values for the flow velocity may vary between a lower limit of 0.1 meters per second and an upper limit of 40 meters per second.

One or more of the present embodiments further relate to a method for measurement of a flow velocity of the multi-phase fluid mixture utilizing the apparatus as described herein. The method includes the generating a sequence of pulses of photons for irradiating a section of the flow of the mixture. The sequence includes at least photons emitted at a first energy level and a second energy level. The method also includes detecting photons that transmitted the section of the flow at different time intervals, and generating a first image of a first spatial distribution from detected photons of a first energy level. The method includes generating a second image of a second spatial distribution from detected photons of the second energy level. The method also includes analyzing the temporal sequence of the first and the second images and determining the flow velocity of one or more phases of the mixture based on the temporal sequence of the first and the second images.

According to one embodiment of a method, each pulse of the sequence is generated so as to include at least photons emitted at the first energy level and the second energy level. Consequently, at least one first image of a spatial distribution of electrons of the first energy level and a second image of a spatial distribution of electrons of the second energy level are generated during the time interval defined by the duration of each pulse. Data acquisition is thus high, so that statistical errors when determining the flow velocity of the multi-phase fluid mixture from the analysis of the temporal sequence of the first and the second images are reduced.

In one embodiment, the x-ray tube emitting the photons is time-dependently controlled by the control device, so that each pulse emitted by the x-ray tube includes at least photons emitted at the first and at the second energy levels. For example, the spectrum of photons emitted by the x-ray tube is shifted so that, in each pulse, photons of the desired first and second energy levels are included.

In one embodiment, the first energy level is a “high energy level” for which the absorption coefficients for both oil and water (e.g., two phases included in the mixture) attain similar low values. The second energy level is chosen so that the photons of the second energy level are absorbed significantly stronger by water than by oil. This allows for an estimation of the concentration of constituents of the mixture that, for example, may also include a gas phase. The absorption due to the gas is negligible for both the photons of the first and the second energy levels.

In one embodiment, the energy levels of the photons included in each pulse is adjusted by continuously varying a voltage applied across the anode and the cathode of the x-ray tube during the duration of each pulse. Adjustment of the voltage results in a shift of the Bremsstrahlungs-spectrum so that the energy levels of the emitted photons may be suitably adjusted. For example, the range of variation of the voltage is chosen so that each pulse contains at least photons of the first and the second energy level.

In a further development, the number of photons contained in each emitted pulse time-dependently may be adjusted according to the sensitivity of the detection device. For example, the number of photons may be adjusted according to the detection sensitivity of the detection device used for detecting the photons of the first and/or a second energy levels. This increases the accuracy of the measurement results (e.g., the accuracy of the evaluated average flow velocity of the fluid mixture). The number of photons emitted by the radiation device is kept in an optimal range corresponding to the detection sensitivity of the detection device.

In one embodiment, an average flow velocity for a part of the flow of the mixture located in a layer of the fluid flow is determined from data detected by a subsection of the two dimensional array of detection element arranged parallel to the flow of the mixture. Average fluid velocity is determined for the layer or slice that extends parallel to a boundary of the conduit. It is well known that the fluid velocity conducted in conduits increases on average with increasing distance from the boundary. Determination of average velocities for different slices or layers thus accounts for realistic hydrodynamic conditions prevalent in conduits or pipes. A total average velocity of the fluid flow may also be calculated from the average fluid velocities of the different layers. The total average fluid velocity features increased accuracy, as a more realistic model has been considered for evaluation.

In one embodiment, the flow velocity of one or more phases of the mixture is determined based on cross-correlation of the temporal sequence of first images and/or second images. The temporal sequence of first images and second images relates to data acquired during time intervals defined by the durations of following pulses. Accordingly, the flow may be monitored and analyzed by image processing, where the total average velocity of the flow of the mixture, the flow velocity of one or more phases of the mixture and/or the average flow velocity for a part (e.g., a layer) of the flow is determined. The method for measuring the flow velocity is a non-intrusive technique that does not interfere with the operation of the industrial plant including the conduit conducting the fluid mixture. For example, the flow in the conduit is not disturbed or interrupted by the measuring process.

### BRIEF DESCRIPTION OF THE DRAWINGS

FIG. 1 shows one embodiment of an apparatus for measurement of a flow velocity of a multi-phase fluid mixture in a sectional view;

FIG. 2 shows a front view of the detection device of the apparatus; and

FIG. 3 illustrates the dependency of a flow velocity of a fluid conducted in a conduit of elliptical cross-section.

Like parts are indicated in all figures with like reference symbols.

### DETAILED DESCRIPTION

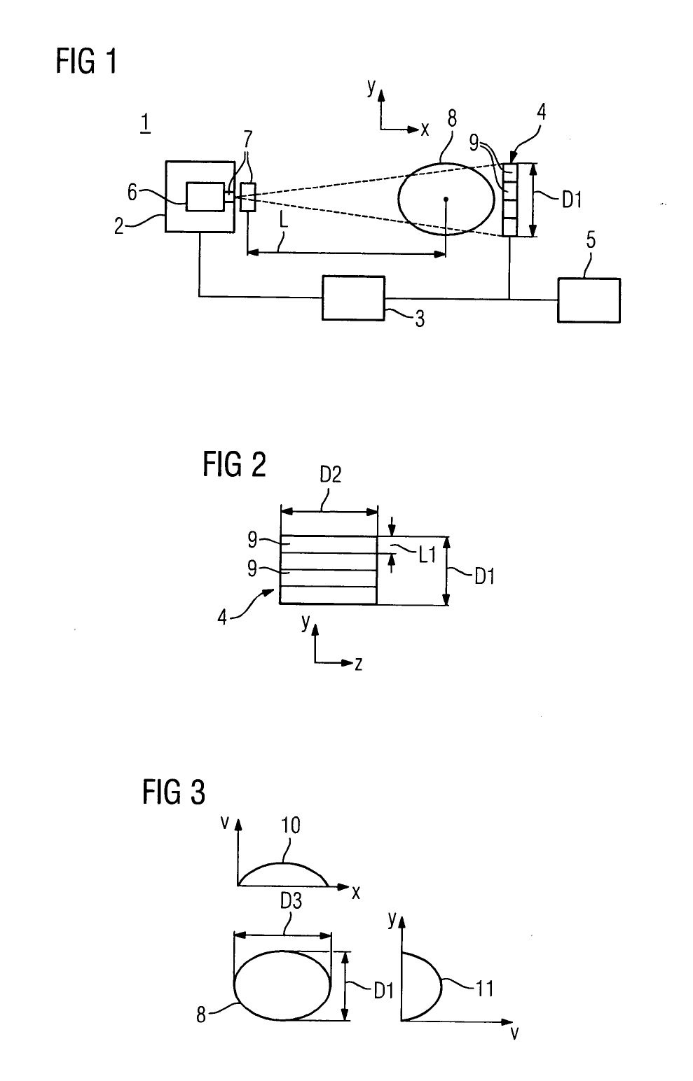

FIG. 1 shows one embodiment of an apparatus 1 for measurement of a flow velocity of a multi-phase fluid mixture. The apparatus 1 includes a radiation device 2, a control device 3 for controlling the radiation device 2, a detection device 4 and an analysis device 5. The radiation device 2 includes a single x-ray tube 6 capable of emitting photons through apertures 7 so as to irradiate a section of a fluid flow conducted in a conduit 8 of elliptical cross-section. The flow direction of the multi-phase fluid mixture flowing within the conduit 8 is perpendicular to the sectional plane shown.

The apparatus 1 is arranged such that the photons emitted from the radiation device 2 travel through the longer extent of the elliptical conduit 8. The photons that are attenuated when transmitting the conduit 8 are detected by the detection device 4. The detection device 4 is configured to generate images of spatial distributions of detected photons at different time intervals. The detection device 4 is connected to the analysis device 5 capable of determining the flow velocity of one or more phases of the mixture based on a temporal sequence of acquired images.

The detection device 4 is further connected to the control device 3 and to the radiation device 2. The arrangement of radiation device 2, control device 3 and detection device 4 forms a control circuit that provides a feedback from the detection device 4 to the radiation device 2. The control circuit is configured to adjust the intensity of each pulse emitted by the radiation device 2 (e.g., the number of photons contained in each pulse) according to values suitable for detection. For example, the number of photons included in each pulse is adjustable to the sensitivity of the detection device 4 for photons of a particular wavelength or energy level.

For adjustment of the intensity of the pulses, the control device 3 is configured to time-dependently vary a current applied to the x-ray tube 6 used for heating a cathode (not illustrated). Additionally, the control device 3 is configured to time-dependently control a voltage applied across the cathode and an anode (not illustrated) of the x-ray tube 6 of the radiation device so as to adjust the energy levels of the photons contained in each pulse emitted by the radiation device 2.

The center of the conduit 8 is located at a distance L from the aperture 7. The multi-phase mixture conducted in the conduit 8 includes phases of a gas, water and oil. The flow velocity of the mixture may be in the range of 0.1 metres per second to 40 metres per second. The flow velocity of the multi-phase mixture may be about 10 metres per second.

When the pulses of photons pass through the conduit 8, the pulses are attenuated. The detection device 4 includes a two dimensional array of detection elements. The array of detection elements of the detection device 4 is subdivided into subsections 9 that are arranged parallel to the conduit 8 and thus parallel to the flow of the mixture. Each subsection 9 of detection elements is configured to discretely screen a layer of the fluid flow. From the data detected by each layer 9 of detection elements, an average flow velocity of the corresponding layer of the fluid flow may be calculated by discrete signal processing. Thus, a hydrodynamic profile of the fluid flow including a realistic dependency of the flow velocity along a first width D1 of the conduit 8 may be taken into account.

The x-ray tube 6 includes only one cathode and one anode. The material of the anode may be any suitable material (e.g., a metal such as gold or molybdenum).

The array of the detection elements is illustrated in more detail in the front view of FIG. 2. The subsections 9 of detector device 4 are oriented parallel to the conduit 8 and extend over a length D2 of the conduit 8. The first width D1 extends parallel to the minor axis of the elliptical cross-section of the conduit 8. A second width D3 extends along the major axis of the elliptical cross-section of the conduit 8.

FIG. 3 illustrates schematically a profile of a fluid velocity that may be encountered in pipes of elliptical cross section. For example, the conduit 8 is considered. The dependency of the fluid velocity v with respect to positions x, y is schematically indicated by graphs 10, 11.

Graph 10 shows the dependency of the flow velocity v with respect to the position x along an x-axis oriented parallel to the major axis of the elliptical cross-section of the conduit 8. The fluid velocity v drops in proximity of the boundaries or walls of the conduit 8. Graph 11 illustrating the dependency of the flow velocity v along the y-axis shows a similar dependency. However, graph 10 is more flat, whereas graph 11 exhibits boundary layers with high velocity gradients. The thickness of the boundary layers adjacent to the boundary of the conduit 8 shown in graph 11 is about 15% of the first width D1. The relative boundary layer thickness along the x-axis is about 7.5% of the second width D3 when the dimensions of the conduit 8 are chosen so that the width D1 is approximately half of the width of D3. Thus, the influence of the boundary layers on the average flow velocity is less in the x-direction. In comparison to the influence of the boundary layers parallel to the y-axis, the influence of the boundary layers parallel to the x-axis on the average fluid velocity is only 1.3%. If a pipe of square cross-section is used, the error introduced when neglecting boundary layer effects is about 2.5%. These numbers indicate that it is beneficial to use a pipe of elliptical cross-section and to irradiate the conduit 8 so that the photons pass through the conduit 8 in the x-direction oriented parallel to the major axis of the elliptical cross-section of the conduit 8.

During operation of the apparatus 1, pulses of photons emanate from the radiation device 2. Each pulse includes photons of a first energy level and a second energy level. The first energy level is a “high energy level” for which the absorption of the water and oil phase contained in the mixture is substantially the same. At the second energy or “low energy” level, the absorption coefficients of oil and water are different. For example, the second energy level may be chosen so that the photons of the second energy level are significantly stronger absorbed by water. The single pulses of the sequence are separated from each other in time. The radiation device 2 thus operates in a pulsed mode. The photons pass through the conduit 8 substantially in the x-direction and get attenuated. The attenuated photons are detected by the detector device 4 that has a resolution of about 1000×2000 pixels. Accurate timing allows for generation of a first image showing a spatial distribution of the photons of the first energy level and a second image showing a spatial distribution of the photons of the second energy level during the duration of each pulse. Sequences of first and second images are consecutively generated from the sequence of pulses emanating from the radiation device 2. The two dimensional array or “detector matrix” of the detection device 4 is subdivided into subsections 9 oriented along a z-axis that extends substantially parallel to the direction of the flow conducted in conduit 8.

During the time between the pulses, the flow covers some distance so that the sequences of first and second images show flow pattern that shift by some number of pixels. The flow velocity is thus analyzed by the analysis device 5 that includes a computer running a program for computation of a volumetric and/or mass flow rate by cross-correlation analysis with respect to the timing between the acquisitions of the images. The mean velocity of each phase is evaluated.

Each subsection 9 is considered separately during the measurement process. Each subsection 9 screens a layer of the fluid flow that extends parallel to the z-axis. The thickness L1 of the screened layer corresponds to the dimension of the subsection 9 parallel to the y-axis, as indicated in FIG. 2. The data (e.g., the sequence of the first images and the sequence of the second images) acquired by the detection device 4 during operation is analyzed separately for each layer defined by one subsection 9 of the detection device 4. Consequently, each layer is attributed a mean or average flow velocity using cross-correlation analysis.

The hydrodynamic velocity profile as shown in FIG. 3 is thus approximated with higher accuracy. Consequently, a total average velocity of the fluid flow is derived with higher accuracy by averaging the average velocities of the individual layers as boundary effects are taken into account. This process may be done for all phases contained in the fluid mixture separately so that the average flow velocities of each individual phase may be evaluated with high accuracy.

During operation, the energy levels of the photons included in each pulse are adjusted by applying a time dependent voltage across the anode and cathode of the x-ray tube 6, so that each pulse contains photons of the first and second energy levels. Additionally, the number of emitted photons is adjusted corresponding to the detection sensitivity of the detection device 4 by applying a time-dependent heating current to the cathode of the x-ray tube 6.

Although the present invention has been described in detail with reference to the embodiments, the invention is not limited by the disclosed examples from which the skilled person is able to derive other variations without departing from the scope of the invention.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. An apparatus for measurement of a flow velocity of a multi-phase fluid mixture, the apparatus comprising:
a radiation device configured to generate a sequence of pulses of photons for irradiating a section of the flow of the multi-phase fluid mixture, wherein the photons are emitted at at least a first energy level and a second energy level;
a detection device configured to detect photons that transmitted the section of the flow at different time intervals so as to generate a first image of a spatial distribution of detected photons of the first energy level and a second image of a spatial distribution of detected photons of the second energy level; and
an analysis device configured to determine the flow velocity of one or more phases of the multi-phase fluid mixture based on a temporal sequence of the first image and the second image of the spatial distributions,
wherein the radiation device is configured to generate single pulses including photons of different energy levels, each pulse including at least photons emitted at the first energy level and the second energy level.

2. The apparatus of claim 1, wherein the radiation device comprises a single x-ray tube and a control unit configured to time-dependently adjust the energy level of the photons emitted by the x-ray tube, so that each pulse emitted by the x-ray tube includes at least photons emitted at the first energy level and the second energy level.

3. The apparatus of claim 2, wherein the control device is adapted configured to continuously vary a voltage applied to the x-ray tube so as to adjust the energy level of the photons emitted by the x-ray tube.

4. The apparatus of claim 2, wherein the control device and the detection device are connected in a control circuit configured to time-dependently adjust the number of emitted photons contained in each pulse, and
wherein the number of photons is adjusted according to a sensitivity of the detection device.

5. The apparatus of claim 4, wherein the control unit is configured to continuously vary a current applied to the x-ray tube so as to time-dependently adjust the number of photons contained in each pulse.

6. The apparatus of claim 1, wherein the detection device comprises a two-dimensional array of detection elements, and the analysis device is configured to determine an average fluid velocity for a part of the flow of the multi-phase fluid mixture from data detected by a subsection of the two-dimensional array of detection elements.

7. The apparatus of claim 1, wherein a conduit conducting the flow of the multi-phase fluid mixture has an elliptic cross-section at least in an irradiated section.

8. The apparatus of claim 1, wherein the analysis device is configured to determine the flow velocity of one or more phases of the multi-phase fluid mixture based on cross-correlation of a temporal sequence of first images, second images, or the first images and the second images.

9. A method for measurement of a flow velocity of a multi-phase fluid mixture utilizing an apparatus, the method comprising:
generating, with a radiation source, a sequence of pulses of photons for irradiating a section of the flow of the multi-phase fluid mixture, the sequence including at least photons emitted at a first energy level and a second energy level;
detecting, with a detector, photons that transmitted the section of the flow at different time intervals;
generating a first image of a first spatial distribution from detected photons of the first energy level;
generating a second image of a second spatial distribution from detected photons of the second energy level; and
analyzing a temporal sequence of the first image and the second image and determining the flow velocity of one or more phases of the multi-phase fluid mixture based on the temporal sequence of the first image and the second image,
wherein each pulse of the sequence of pulses is generated so as to include at least photons emitted at the first energy level and at the second energy level.

10. The method of claim 9, further comprising time-dependently controlling an x-ray tube by a control unit, so that each pulse emitted by the x-ray tube includes at least photons emitted at the first energy level and the second energy level.

11. The method of claim 10, wherein a voltage applied across an anode and a cathode of the x-ray tube is continuously varied so as to adjust the energy level of the photons included in each pulse.

12. The method of claim 10, wherein the number of photons contained in each emitted pulse is time-dependently adjusted according to a sensitivity of the detector.

13. The method of claim 12, wherein a current applied to the x-ray tube is continuously varied so as to time-dependently adjust the number of photons contained in each pulse.

14. The method of claim 9, further comprising determining an average fluid velocity for a part of the flow of the multi-phase fluid mixture from data detected by a subsection of a two dimensional array of detection elements.

15. The method of claim 9, further comprising determining the flow velocity of one or more phases of the multi-phase fluid mixture based on cross-correlation of the temporal sequence of first images, second images, or the first images and the second images.

16. The apparatus of claim 4, wherein the number of photons is adjusted according to a detection sensitivity for photons of the first energy level, the second energy level, or the first energy level and the second energy level.

17. The method of claim 12, wherein the number of photons contained in each emitted pulse is time-dependently adjusted according to a detection sensitivity for photons of the first energy level, the second energy level, or the first energy level and the second energy level.
